(19) United States
(12) Patent Application Publication
(10) Pub. No.: US 2025/0190188 A1
(43) Pub. Date: Jun. 12, 2025

(54) INCREMENTAL LOADING FOR USER INTERFACE DESIGN FILES

(71) Applicant: Figma, Inc., San Francisco, CA (US)

(72) Inventors: Isaac Goldberg, San Francisco, CA (US); Naomi Jung, San Francisco, CA (US); Andrew Swan, San Francisco, CA (US); Georgia Rush, San Francisco, CA (US)

(21) Appl. No.: 18/971,747

(22) Filed: Dec. 6, 2024

Related U.S. Application Data
(60) Provisional application No. 63/607,765, filed on Dec. 8, 2023.

(51) Int. Cl. G06F 8/38; G06F 9/451

(52) U.S. Cl. CPC G06F 8/38; G06F 9/451

(57) ABSTRACT

A computing device can detect a selection input by a user of the computing device to open a user interface (UI) design file and initiate a UI design session. In response to the selection input, the computing device can incrementally load the UI design file to the computing device of the user for presentation on a display device of the computing device.

### RELATED APPLICATION(S)

This application claims benefit of priority to Provisional U.S. Patent Application No. 63/607,765, filed Dec. 8, 2023; the aforementioned priority application being hereby incorporated by reference in its entirety for all purposes.

### TECHNICAL FIELD

Examples described herein relate generally to performance improvements for collaborative web services.

### BACKGROUND

Software design tools have many forms and applications. In the realm of application user interfaces, for example, software design tools enable designers to blend functional aspects of a program with aesthetics, resulting in a collection of pages that form the user interface of an application.

### BRIEF DESCRIPTION OF THE DRAWINGS

FIG. 1A is a block diagram illustrating a user computing device in communication with a network computer system, according to one or more embodiments.

FIG. 1B illustrates a network computer system implementing a collaborative web service, according to one or more embodiments.

FIG. 2A illustrates an example collaboration interface for creating a user interface (UI) design file, according to one or more embodiments.

FIG. 2B illustrates an example collaboration interface during a collaboration session with multiple users collaborating on a UI design, according to one or more embodiments.

FIGS. 2C through 2E illustrate a sequence of dynamically and/or incrementally loading a UI design file, according to one or more embodiments.

FIG. 3A illustrates process for incremental loading of UI design files, according to one or more embodiments.

FIG. 3B illustrates a process for incremental loading and change data propagation for a plurality of remote collaborators, according to one or more embodiments.

FIG. 3C illustrates a process for automatic incremental preloading of UI design files based on predictive information, according to one or more embodiments.

FIG. 3D illustrates a process for determining an optimal strategy for preparing a UI design file for a user, according to one or more embodiments.

FIG. 4 is a block diagram illustrating a computer system on which one or more embodiments can be implemented.

FIG. 5 is a block diagram illustrating a user computing device for use with one or more examples described herein.

### DETAILED DESCRIPTION

Examples described herein involve providing a collaborative web service in which users can collaborate with other remote users to design user interfaces and overall user experience (e.g., for an application). In various examples, a user can execute a browser application on a computing device to interact with a current user interface (UI) design file. Each UI design file of the user can be stored in a backend computing system, and can comprise a design under edit for a particular UI or graphical user interface (GUI). As provided herein, each UI design under edit can include a set of UI pages that the user can edit to configure a user experience. As provided herein, a “design under edit” and “design in progress” may be used interchangeably, and can refer to a current UI design that is configurable and editable by the user and/or a set of remote user collaborators. According to embodiments described herein, the user and one or more remote users can each provide input to edit and configure the set of UI pages with interactive features (e.g., selectable buttons or icons, text boxes, search boxes, embedded links, links to other pages in the set of UI pages, drop down menus, etc.).

A computing device can execute a browser application for enabling a user to configure and provide edits to a UI design file comprising any number of UI pages. In previous implementations, the browser application would load the entire UI design file, or multiple UI design files selected by the user, which can cause delays in loading time and may result in an out-of-memory condition in the browser memory. In accordance with examples provided herein, the browser application can detect a selection input by the user of the computing device to open a user interface (UI) design file and initiate a UI design session.

In response to the selection input, the browser application can incrementally load the UI design file for rendering on the computing device. For example, the browser application can sequentially load each respective UI page of a plurality of UI pages of the UI design file to the computing device based on selective inputs by the user selecting each respective UI page. As such, the UI pages can load with increased speed and more efficient memory usage than with previous implementations.

In various examples, the browser application can incrementally load the UI design file to the computing device of the user by retrieving individual UI pages of the UI design file from a backend network computer system based on the user providing input to select each of the individual UI pages. In further examples, the browser application can enable a plurality of remote collaborators to participate in the UI design session with the user and provide input for updating the UI design file and implement incremental loading on each computing device of each remote collaborator.

In certain implementations, the browser application can incrementally load the UI design file by performing dynamic content loading, in which individual content features of each UI page are loaded separately as the user provides inputs, such as scroll inputs, page selection inputs, or individual feature selections. For example, a UI page may include several interactive icons, images, buttons, and other UI design features that consume browser memory. When these features are simultaneously present on a UI page, some amount latency may occur if they are loaded simultaneously. The browser application may load each UI design feature separately as they are presented and/or as the user interacts with the individual features.

In one embodiment, the browser application includes a memory optimizer that determines whether dynamic content loading may be more optimal for browser memory usage than incrementally loading entire UI pages. For example, the memory optimizer can identify multiple memory intensive UI features on a particular UI page and determine that loading the entire UI page may cause a delay (e.g., exceeding a threshold loading time or due to the UI page exceeding a threshold checkpoint size), which can impact user experience in interacting with the collaborative web service. If the memory optimizer determines that dynamic content loading is more optimal, the memory optimizer can cause the browser application to perform dynamic content loading such that individual UI features (e.g., cards) are loaded (e.g., as they appear on the user's display or as the user interacts with those features).

In certain scenarios, an unloaded UI page can include one or more UI features that are affected by edits made to the UI features by one of the remote collaborators. Change data corresponding to the edits can be transmitted to a backend computer system that stores active workspace data corresponding to the UI design file, and the computer system can propagate the changes on the backend to the UI design file. When the unloaded page is selected by the user for incremental loading, the edits made by the remote collaborator will be present when the unloaded UI page is loaded to the computing device of the user.

In certain aspects, each time a respective remote collaborator makes edits to a particular UI page, change data is transmitted from the computing device of the remote collaborator to the backend computer system to automatically update the active workspace data and propagate the edits to the computing devices of the other collaborators such that when these collaborators select the particular UI page, the edits have been incorporated. Accordingly, edits made by each of the plurality of remote collaborators to any UI page of the UI design file are propagated to active workspace data corresponding to the UI design file at the backend network computer system.

Accordingly, the browser application implements incremental file loading for UI design files for browser memory usage efficiency, increased speed in loading UI design pages, and overall improvement in computing performance. In such examples, when a user opens a current UI design file with a UI design under edit that comprises multiple UI pages, the computing system can load each UI page to the user's browser memory as the user requests them or otherwise seeks to interact with them. For unloaded UI pages that include one or more dependencies on a particular UI page that has been incrementally loaded to the computing device of the user, the edits made to the loaded UI page will be automatically propagated to the unloaded pages on the backend. Accordingly, when the unloaded page is selected by the user, the unloaded page will reflect the changes made to the previously loaded UI page.

As provided herein, the one or more dependencies may involve the use of or interaction with an icon, button, link, or other user input that must be selected or otherwise interacted with prior to accessing a latter U page. The computing device can propagate changes to any unloaded UI pages that depend on or are otherwise affected by the UI page based on the change data prior to loading the set of unloaded UI pages to the computing device of the user.

In further implementations, the backend computer system can implement one or more machine learning techniques to predict which UI pages of a particular UI design file the user is likely to open, and can cause the browser application to automatically preload these predicted UI pages to the local browser storage. One of the factors in these machine learning techniques can comprise recency. Additional factors can include user-specific information or one or more aspects specific to the user, such as any routines of the user (e.g., the user typically opens a particular design file on a particular day of the week and/or time of day), whether a UI design page includes a comment mentioning the user or a tag linked to the user, and the like. Other machine learning predictions are also contemplated, such as the backend computer system linking to one or more third-party services of the user (e.g., email, social media, browser history, calendar, and other application services) and generating a real-time user profile that can be processed to predict which UI design pages the user will want to edit in a given session.

In certain implementations, the browser application may determine that loading multiple UI pages or an entire UI design file may be faster than performing incremental loading of the UI design file. For example, the checkpoint size of a particular UI design file (e.g., a small UI design file having a few UI pages) may be such that no benefit would result from incrementally loading the UI design file. In such examples, the memory optimizer of the browser application can trigger the browser application to load the entire UI design file. Furthermore, the browser application may perform incremental loading by default, and upon determining that loading the entire UI design file would be more beneficial than incremental loading, the memory optimizer can trigger the browser application to load the entire UI design file.

In further implementations, the backend network computer system can collect predictive information corresponding to each individual user, such as user activity data indicating which UI design files, individual UI pages, and/or UI features of UI pages with which the user is likely to interact. For example, the network computer system can create a user profile of the user that indicates which UI design files with which the user has recently interacted and/or provided edits, includes any routine behaviors of the user (e.g., the user routinely opens a particular UI design file on a particular day of the week), and/or includes calendar information of the user (e.g., identifying any upcoming UI design collaboration sessions in which the user and one or more collaborators are to work on a particular UI design file).

Based on the predictive information, the browser application may be triggered to incrementally preload certain UI pages or perform dynamic content preloading upon the user launching the browser application. As such, based on predicting that the user will work on a particular UI page of a particular UI design file, the browser application can preload that UI page when the user launches the browser application. Such predictions may be based on recency of the user interacting with the UI page, activity or routine information specific to the user, calendar information indicating that the user will work on the UI page in a collaboration session, and the like.

It is contemplated that any of the discussed incremental loading, dynamic content loading, or predictive preloading embodiments can be implemented by default, or may be triggered based on a determination that the embodiment will result in a performance improvement. Accordingly, an initial step of processing UI file data of a particular UI design file may be performed by the browser application to determine whether incremental loading, dynamic content loading, predictive preloading, or any combination of these methods may be the most optimal manner of preparing a UI design file for the user. Upon performing this optimization, the browser application may implement one or more of these methods accordingly.

In further examples, the browser application may automatically evict certain UI pages or individual UI features during the design session or collaboration session of the user. For example, the browser application can determine that a user has not interacted with a loaded UI page or individually loaded content features for a certain time period (e.g., a few minutes). The browser application can perform a snapshot of the UI page or the individual content features, and all the changes that the user has made to the UI page or content features can be archived on the backend. Thereafter, the UI page or individual content features can be presented as a snapshot on the user's display while consuming substantially no browser memory.

For example, when a UI page or an individual content feature on the UI page is incrementally loaded, the browser application can initiate a timer for that UI page or content feature. Whenever the user interacts with the UI page or the content feature, the browser application can reset the timer. However, when the timer reaches a time limit for the UI page or the content feature, the browser application can automatically evict the UI page or the content feature.

In accordance with various examples, a collaboration session comprising multiple remote collaborators can involve the incremental loading and/or predictive preloading of UI design files, individual UI pages of the UI design files, and/or individual content items, such as nodes, sub-nodes, cards, and the like. The user experience for each collaborator is unique even though they may collaborate on the same UI design file, which is updated in real time at the backend network computing system. In certain examples, different personas of the collaborators (e.g., corresponding to those that have editing abilities, those that only comment on a design file, and/or administrators) can experience incremental loading differently, depending on the functions of each persona. For example, the editing tools for a commentor that does not have editing capabilities may be disabled, and so the UI design file may be incrementally loaded to remove such features, which can result in more efficient browser memory usage.

In certain implementations, when an offline trigger is detected, the browser application can process change data corresponding to user input by the user interacting with any loaded pages of a UI design file or any of the preloaded UI design pages in the browser storage. When the network communication interface of the user's computing device reconnects with the backend network computer system, the browser application can synchronize the change data corresponding to the user edits to the loaded UI design pages with the UI design file stored in the backend computer system. Accordingly, the user's changes to each loaded UI page managed by the browser application in the browser storage in the offline mode can be propagated to the corresponding UI design file stored at the backend when the network connection between the computing device and the network computer system is restored.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices and/or tablets), and magnetic memory. Computers, terminals, network-enabled devices (e.g., mobile devices, such as cell phones) are all examples of machines and devices that utilize processors, memory, and instructions stored on computer-readable mediums. Additionally, embodiments may be implemented in the form of computer programs, or a computer-usable carrier medium capable of carrying such a program.

### System Description

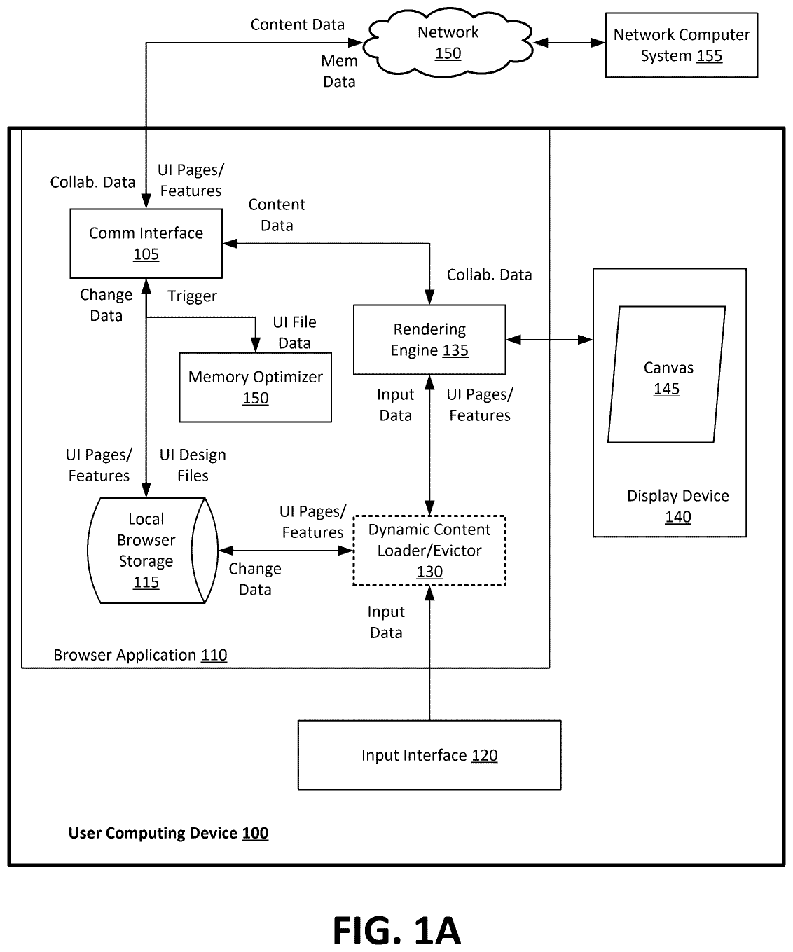

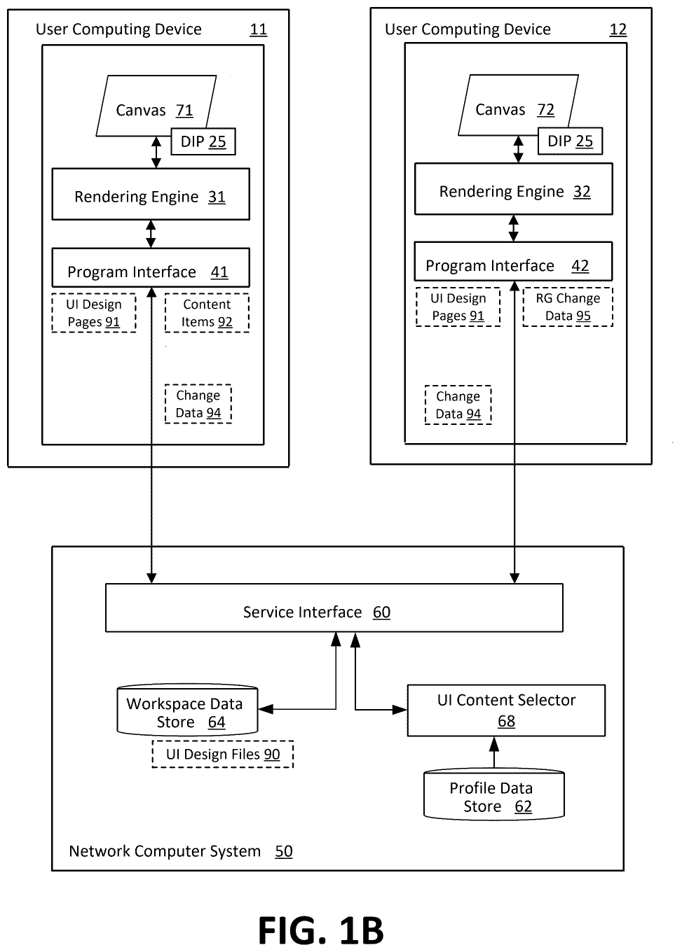

FIG. 1A is a block diagram illustrating a user computing device 100 in communication with a network computer system, according to one or more examples. In various implementations, the user computing device 100 can include a communication interface 105 that communicates with a network computer system 155 over a network 150 (e.g., Wi-Fi, cellular, satellite, etc.). As provided herein, the network computer system 155 can implement a collaborative web service that enables remote users to collaborate on user interface (UI) designs that combine to provide a user experience (UX) for users of application programs.

In various examples, the user computing device 100 can comprise any personal computer, such as a tablet computer, desktop computer, laptop device, smartphone device, augmented reality (AR) or virtual reality (VR) headset device, and the like. The user computing device 100 can comprise an input interface 120, which can comprise a keyboard and mouse, a touch interface such as a track pad or touch-sensitive display, an interactive virtual display, and the like. The user computing device 100 can further include a display device 140, such as a computer screen or touch-sensitive display.

In various examples, the user computing device 100 can operate a browser application 110, which the user computing device 100 can initiate to provide access to the collaboration service implemented by the network computer system 155. The browser application 110 can be executed to initiate a network connection with the network computer system 155 to enable a plurality of remote users to collaborate on one or more designs under edit corresponding to respective UI design files. For example, the user may include an account and/or profile with the network computer system 155 that includes a set of UI design files, which the user can edit and configure until finalized.

In various implementations, when the browser application 110 is initiated, the browser application 110 can automatically load a set of UI design files of the user to the local browser storage 115 for the purpose of mitigating offline triggers, such as when the user's network connection or the network computer system's network connection fails. Such failures can occur based on network outages or power outages on either the frontend or the backend (e.g., due to storms, natural disasters, network infrastructure maintenance and upgrades, and the like). Such outages may last for several hours or even days, which can cause delays in meeting user deadlines or particular UI design files.

In some implementations, when an offline trigger occurs, the user is only able to interact with a currently loaded UI design file, even when the user wishes to access and provide input to multiple UI design files. Examples described herein provide for the preloading of multiple UI design files to the local browser storage 115 so that an offline trigger will still allow the user to access and interact with any of the preloaded UI design files. For example, the user's UI design files may be stored in the backend network computer system 155 and accessible through execution of the browser application 110. During a normal session, the user can open a particular UI design file, which can comprise any number of interactive UI pages under edit.

As a background operation, the browser application 110 can preload additional UI design files or individual pages of a UI design file to the local browser storage 115 (e.g., based on recency or machine-learning predictions). When the user interacts with a particular UI design file, input data is received via the input interface 120, which can comprise keyboard/mouse inputs, stylus inputs, touch inputs, and the like. Based on the user inputs, a UI design under edit-corresponding to the UI design file-can be presented, edited, and configured by the user on a collaborative canvas 145 displayed on the display device 140. The user's edits on the UI design file can then be propagated to collaborative canvases presented on computing devices of any number of other users during a collaboration session.

Along these lines, contributions from the other users to a UI design under edit can be propagated as collaboration data by the network computer system 155 to the design under edit presented on the canvas 145 displayed on the display device 140. Accordingly, the user and the remote users can engage with each other in real time during a collaboration session to provide input and edits to the design under edit. For example, input data from the user can be processed by a rendering engine 135 of the browser application 110, which can generate content data to be displayed on the canvas 145 and transmitted over the network 150 to the network computer system 155 for propagation to the computing devices of other users in the collaboration session. As described, the browser application 110 also propagates the inputs provided by the other participants to the collaborative canvas 145 presented on the display device 140 of the user computing device 100. In certain examples, the browser application 110 can execute scripts, code, and/or other logic (the “programmatic components”), provided by network computer system 155, to implement the functionality of the rendering engine 135 described herein.

In certain examples, the browser application 110 can be implemented as web code that can include (but is not limited to) Hyper-Text Markup Language (HTML), JAVASCRIPT, Cascading Style Sheets (CSS), other scripts, and/or other embedded code which the browser application 110 receives from a network site. For example, the browser application 110 can execute web code that is embedded within a web page. The web code can also cause the browser application 110 to execute and/or retrieve other scripts and programmatic resources (e.g., libraries) from the network site and/or other local or remote locations. By way of example, the browser application 110 may include JAVASCRIPT embedded in an HTML resource (e.g., web page structured in accordance with HTML 5.0 or other versions, as provided under standards published by W3C or WHATWG consortiums) that is executed by the browser application 110. In some examples, the content rendering engine 135 of the browser application may utilize graphics processing unit (GPU) accelerated logic, such as provided through WebGL (Web Graphics Library) programs which execute Graphics Library Shader Language (GLSL) programs that execute on GPUs.

In some implementations, the rendering engine 135 can generate the collaborative canvas 145 using programmatic resources that are associated with a browser application (e.g., an HTML 5.0 canvas). As an addition or variation, the rendering engine 135 can trigger or otherwise cause the collaborative canvas 145 to be generated using programmatic resources and data sets (e.g., canvas parameters) which are retrieved from local (e.g., memory) or remote sources (e.g., from network computer system 155).

The browser application 110 may also retrieve programmatic resources that include an application framework for use with the collaborative canvas 145. The application framework can include data sets that define or configure a set of interactive graphic tools that integrate with the collaborative canvas 145. For example, the interactive graphic tools may enable the user to provide input for creating and/or editing a design interface.

Additionally, the rendering engine 135 can interpret an input action of the user based on the location of the detected input (e.g., whether the position of the input indicates selection of a tool, an object rendered on the collaborative canvas 145, or region of the canvas 145), the frequency of the detected input in a given time period (e.g., tap and hold), and/or the start and end position of an input or series of inputs (e.g., start and end positions of a drag input), as well as various other input types which the user can specify (e.g., pinch, zoom, scroll, etc.) through one or more input devices. In this manner, the rendering engine 135 can interpret, for example, a series of inputs as a design tool selection (e.g., shape selection based on location/s of input), as well as inputs to define properties (e.g., dimensions) of a selected shape.

In various examples, the rendering engine 135 operates to generate the user interface-which can include a design in progress-presented on the display device 140. The user interface can include graphic elements and their respective properties to enable the user to edit the design under edit using the input interface 120. As an addition or alternative, the rendering engine 135 can generate a blank page for the collaborative canvas 145, and the user can interact with various displayed tools to initiate a design under edit. As rendered, the design under edit can include graphic elements such as a background and/or a set of objects (e.g., shapes, text, images, programmatic elements), as well as properties of the individual graphic elements.

Each property of a graphic element can include a property type and a property value. For an object, the types of properties include shape, dimension (or size), layer, type, color, line thickness, font color, font family, font size, font style, and/or other visual characteristics. Depending on implementation details, the properties reflect attributes of two-or three-dimensional designs. In this way, property values of individual objects can define visual characteristics such as size, color, positioning, layering, and content for elements that are rendered as part of the design in progress.

Individual design elements may also be defined in accordance with a desired run-time behavior. For example, some objects can be defined to have run-time behaviors that are either static or dynamic. The properties of dynamic objects may change in response to predefined run-time events generated by the underlying application that is to incorporate the design in progress. Additionally, some objects may be associated with logic that defines the object as being a trigger for rendering or changing other objects, such as through implementation of a sequence or workflow. Still further, other objects may be associated with logic that provides the design elements to be conditional as to when they are rendered and/or their respective configuration or appearance when rendered. Still further, objects may also be defined to be interactive, where one or more properties of the object may change based on user input during the run-time of the application.

In various implementations, the browser application 110 enables a user to interact with the canvas 145 to create design elements, where design elements can have spatial and logical relationships one another. Design elements can be linked, for example, as having parent/child relationship, or alternatively referred to as nested design elements. In examples, nested design elements can have a spatial and logical relationship with one another. For example, a design element can be nested within another design element, meaning a boundary or frame of the design element (e.g., child element) is contained within the boundary or frame of the other design element (e.g., parent element).

Further, nested design elements can be logically linked, such as in a manner where design input to either design element can trigger rules or other logic that affect the other design element. The rules or logic that affect nested design elements can serve to maintain the design elements in their spatial relationship, such that one node remains the parent of the other (or one node remains the child of the other) despite, for example, resize or reposition input that would otherwise affect the parent-child spatial relationship. Thus, for example, nested design elements can be subject to a common set of constraints, as well as other functional features (e.g., auto-layout). Still further, as another example, the design input to move one of the design elements of a nested pair can result in the other design element being moved or resized.

Further, browser application 110 enables users to specify flows that specify sequences (including alternative sequences) amongst multiple cards. For example, a user can specify logical connections amongst a collection of cards, where the logical connections specify a sequence. As individual cards may specify, for example, alternative states of same screen or interface, the use of such logical connectors can specify state changes or flows of the user interface or presentation when in production, where the state changes or flows are responsive to events (e.g., user input) which may occur in such production-environment. The browser application 110 can determine and utilize a common hierarchical logical data structure to represent a collection of cards.

For example, a hierarchical nodal representation can be maintained for the collection of cards, where the representation includes a top-level node and sub-nodes with additional hierarchically arranged nodes. Accordingly, in examples, each card of the collection can be represented by a root node (Level 0, or top-most level node), and each design element can be represented as a sub-node of the root node. Within each root node, sub-nodes can be arranged to have different levels. A top-most sub-node of the root node (i.e., Level 1 node) can include design elements of the card that are not children of any other design elements except for the top-level frame represented by the root node. In turn, any child design element to one of the design elements represented by a top-level sub-node (Level 1) can be represented by a second level sub-node (i.e., Level 2 node) and so forth. The design-mode nodal representation can be determined for each card, and further combined for all the cards of the collection. The design-mode nodal representation of the collection can be provided by the browser application 110 as, for example, part of a separate panel in a tool panel presented on the canvas 145.

The rendering engine 135 can process input data corresponding to user inputs provided on the display device 140, where the input data indicates (i) an input action type (e.g., shape selection, object selection, sizing input, color selection), (ii) an object or objects that are affected by the input action (e.g., an object being resized), (iii) a desired property that is to be altered by the input action, and/or (iv) a desired value for the property being altered. The rendering engine 135 can implement changes indicated by the input data to locally update active workspace data presented on the display device 140. The rendering engine 135 can update the collaborative canvas 145 to reflect the changes to the affected objects in the design under edit.

In various implementations, the browser application 110 can include a mode trigger module that can detect memory triggers (e.g., initial memory triggers and critical memory triggers) as well as offline triggers that indicate that either the user computing device 100 or the network computer system 155 has lost network connectivity. When an offline trigger is detected, the collaboration session is terminated and the contributions from the user and the remote users in the collaboration session are no longer propagated in real time.

According to embodiments described herein, when an offline trigger is detected, the browser application 110 can initiate an offline mode in which the user may still engage with a current UI design file that is open and presented on the canvas 145, as well as the set of UI design files and/or individual UI pages of a UI design file that were automatically preloaded by the browser application 110 at launch. For example, the design under edit of a particular UI design file can include a set of functions that enables the user to edit and configure individual UI pages, which are preserved in the offline mode. Additionally, the user can open one of the UI design files preloaded to the local browser storage 115, and edit and configure the individual UI pages of that UI design file accordingly. Change data corresponding to the user's edits and configurations can be saved automatically by the browser application 110 in the local browser storage 115.

In embodiments, an offline mode trigger can further cause the rendering engine 135 to cease transmitting content data to the network computer system 155, and instead have change data corresponding to user inputs on the UI design under edit stored in the local browser storage 115. According to examples, when network connectivity is restored, the browser application 110 can operate in a normal online mode and/or restore the collaboration session. The change data corresponding to the user's input during the offline mode can be propagated to the corresponding UI design file(s) stored at the network computer system 155, and thus propagated to the UI design(s) under edit presented on the computing devices of the remote users in the collaboration session.

In certain implementations, the browser application 110 can implement incremental loading of a particular UI design file, in which individual pages of the UI design file are loaded based on user selections of each of the individual pages. In an example of FIG. 1, a UI design file comprising any number of UI pages may be stored at the network computer system 155. Upon launching the browser application 110, the user may select from individual UI pages of the UI design file, which may be loaded to the browser storage 115 individually as requested.

In variations, the browser application 110 can incrementally load a particular UI design file selected by the user by performing dynamic content loading. In such variations, the browser application 110 can include a dynamic content loader/evictor 130 that responds to input data from the user, and loads individual content features (e.g., cards) of each UI page separately as the user provides inputs, such as scroll inputs, page selection inputs, or individual feature selections. For example, a UI page comprising multiple cards may include several interactive icons, images, buttons, and other UI design features that consume browser memory. When these features are simultaneously present on a UI page, some amount latency may occur if they are loaded simultaneously.

In an example, the browser application 110 can include a memory optimizer 150 that determines whether dynamic content loading may be more optimal for browser memory usage than incrementally loading entire UI pages. The memory optimizer 150 can process UI file data of a particular UI design file selected by the user, and can identify multiple memory intensive UI features on a particular UI page. Based on processing the UI file data, the memory optimizer 150 may determine that loading the entire UI page may cause loading delays, which can correspond to a calculated or estimation loading time exceeding a threshold loading time or the UI page exceeding a threshold checkpoint size. When the memory optimizer 150 determines that dynamic content loading is more optimal, the memory optimizer 150 can cause the browser application 110 to trigger the dynamic content loader/evictor 130 to perform dynamic content loading such that individual UI features are loaded (e.g., as they appear on the user's display or as the user interacts with those features).

In further examples, upon the user selecting a particular UI design file, the memory optimizer 150 may process the UI file data of the UI design file to determine an optimal manner in which the UI design file is to be loaded, such as whether incremental loading of one or more whole UI pages would result in increased performance benefit over dynamic content loading those UI pages, or whether loading the whole UI design file would be more beneficial than incremental loading. Based on the optimization, the memory optimizer 150 can trigger the communication interface 105 to prepare the UI file accordingly. This preparation of the UI design file can comprise any combination of incremental loading whole UI pages (e.g., UI pages that are less memory intensive) or dynamic content loading of certain UI pages (e.g., UI pages having memory intensive features).

In certain implementations, based on the checkpoint size or other file characteristics of a particular UI design file (e.g., a small UI design file having a few UI pages) the memory optimizer 150 may determine that no performance benefit would result from incrementally loading the UI design file. In such a scenario, the memory optimizer 150 can trigger the communication interface 105 to load the entire UI design file accordingly.

In some aspects, the network computer system 155 implementing the collaboration service can select UI pages for any particular UI design file to be automatically preloaded to the local browser storage 115 to improve loading performance on the computing device 100. In one example, the network computer system 155 selects UI pages based on recency of use. For example, if the user has been working on a set number of UI pages of one or more UI design file, the browser application 110 may select these individual pages for preloading in the local browser storage 115. Other select methods of preloading UI design pages are contemplated, such as machine learning methods that account for individual behaviors, preferences, and or routines. In one example, the user may select a set of preferred UI design pages for preloading (e.g., by periodically ranking or selecting UI page by importance to the user).

In further examples, the network computer system 155 can perform machine learning techniques to predict which UI pages the user is likely to require in any given collaboration session. Certain factors may be used, such as learned activity data, routines, or behaviors (e.g., the user routinely accessing a UI page of a particular UI design file on a specific time of day and/or day of the week), whether the user was tagged or pinged in a particular UI page (or individual content items or cards for dynamic content loading) by another collaborator, when the user's name was included in a comment on a particular UI design file or UI page, and the like. In further aspects, the network computer system 155 may have information access to other applications and data on the user computing device 100, which can indicate which UI pages the user is likely to access. Such information may include calendar data indicating collaboration sessions and/or meetings the user is to attend that require access to a particular UI page. As provided herein, the network computer system 155 can make a machine learned prediction based on the individual characteristics or information associated with the user to select with UI pages to preload to the local browser storage 115 upon initiation of the browser application 110.

Embodiments described herein recognize that a single UI design file or multiple UI design files saved and/or preloaded to the local browser storage 115 can be memory intensive. For example, when the user and/or collaborators add to and configure a UI design file to comprise several UI pages with various functionality, browser memory is increasingly consumed by the UI design file. When a critical memory threshold is exceeded (e.g., the browser limit), the user is typically locked out of being able to use the browser, either to engage with the browser application 110 or to perform any other browser functions.

In certain examples, the dynamic content loader/evictor 130 can further operate to evict UI pages, cards, and/or content items when the user has not viewed or interacted with the UI pages, cards, and/or content items. For example, the dynamic content loader/evictor 130 may automatically evict certain UI pages or individual UI features (e.g., cards) during the design session or collaboration session of the user. For example, the dynamic content loader/evictor 130 can determine that a user has not interacted with a loaded UI page or individually loaded content features (e.g., individual cards) for a certain time period (e.g., a few minutes). In one example, the dynamic content loader/evictor 130 can perform a snapshot of the UI page or the individual content features or cards, which can replace the memory consuming features of the UI page or the individual content features or cards. As provided herein, all updates, edits, and/or other changes may by the user to the evicted UI page, content features, or cards can be preserved at the backend network computer system 155.

In further implementations, the backend network computer system 155 can collect predictive information corresponding to each individual user, such as user activity data indicating which UI design files, individual UI pages, and/or UI features of UI pages with which the user is likely to interact. For example, the network computer system can create a user profile of the user that indicates which UI design files with which the user has recently interacted and/or provided edits, includes any routine behaviors of the user (e.g., the user routinely opens a particular UI design file on a particular day of the week), and/or includes calendar information of the user (e.g., identifying any upcoming UI design collaboration sessions in which the user and one or more collaborators are to work on a particular UI design file).

Based on the predictive information, the memory optimizer 150 can trigger the communication interface 105 to incrementally preload certain UI pages or perform dynamic content preloading upon the user launching the browser application. As such, based on predicting that the user will work on a particular UI page of a particular UI design file, the browser application can preload that UI page when the user launches the browser application. Such predictions may be based on recency of the user interacting with the UI page, activity or routine information specific to the user, calendar information indicating that the user will work on the UI page in a collaboration session, and the like.

It is contemplated that any of the discussed incremental loading, dynamic content loading, or predictive preloading embodiments can be implemented by default, or may be triggered based on a determination that the embodiment will result in a performance improvement. Accordingly, an initial step of processing UI file data of a particular UI design file may be performed by the browser application to determine whether incremental loading, dynamic content loading, predictive preloading, or any combination of these methods may be the most optimal manner of preparing a UI design file for the user. Upon performing this optimization, the browser application may implement one or more of these methods accordingly.

### Collaborative Network Platform

FIG. 1B illustrates a network computer system implementing a collaborative web service, according to one or more examples. In an example of FIG. 1B, a collaborative network platform is implemented by the network computer system 50, which communicates with multiple user computing devices 11-12 over one or more networks (e.g., the World Wide Web) to present a shared, collaborative design interface on the user computing devices 11-12. While FIG. 1B illustrates an example in which two users utilize the collaborative network platform, examples as described allow for the network computer system 50 to enable collaboration on design interfaces among users using a larger number of user computing devices. Among other advantages, the collaborative network platform allows users to more concurrently access a design interface, and to conveniently manipulate objects while the network computer system 50 manages synchronization and access issues.

With respect to FIG. 1B, the user computing devices 11-12 can be operated by users that are associated with a common account or accounts associated with a particular design in progress 25. Each user computing device 11-12 presents the design in progress 25 on a collaborative canvas 71-72 presented on each device during respective sessions. As such, each of the user computing devices 11-12 may access a UI design file 90 at the same time using respective program interfaces 41-42 on each of the user computing devices 11-12.

In examples, the service interface 60 can load the UI design file 90 corresponding to the design in progress 25 from a workspace data store 64, and transmit individual UI pages 91 of the UI design file 90 to each user computing device 11-12 such that the respective rendering engines 31-32 render the design in progress 25 corresponding to the UI design file 90, such as during overlapping sessions. In some examples, the network computer system 50 can continuously synchronize the edits to the UI design file 90 corresponding to the design in progress 25 presented on the user computing devices 11-12. Thus, changes made by users to the design in progress 25 on one user computing device 11 may be reflected on the design in progress 25 rendered on the other user computing device 12 in real-time. By way of example, when a change is made to the design in progress 25 at one user computing device 11, the respective rendering engine 31 updates the respective canvas 71 locally and transmits change data 94 corresponding to the changes to the service interface 60 of the network computer system 50 (e.g., via content rendering engine 135).

The service interface 60 processes the change data 94 from the user computing device 11 and uses the change data 94 to make a corresponding change to the UI design file 90. The service interface 60 can also transmit remotely-generated change data 95 (which in the example provided, corresponds or reflects the change data 94 received from the user computing device 11) to the other user computing device 12 that has loaded the same design in progress 25, causing the corresponding rendering engine 32 to generate the changes to the design in progress 25 accordingly, such as by causing the program interface 42 and rendering engine 32 to update the respective collaborative canvas 72. In this manner, active workspace data 90 is synchronized across any number of user computing devices 11-12 that are using the respective UI design file 90.

In certain examples, to facilitate the synchronization of the edits and changes made at the user computing devices 11-12 and the network computer system 50, the network computer system 50 may implement a stream connector to merge data streams between the network computer system 50 and user computing devices 11-12 that have loaded the same design in progress 25. For example, the stream connector may merge a first data stream between user computing device 11 and the network computer system 50 with a second data stream between user computing device 12 and the network computer system 50. In some implementations, the stream connector can be implemented to enable each computing device 11-12 to make changes to the server-side UI design file 90 without added data replication that may otherwise be required to process the streams from each user computing device 11-12 separately.

In various examples, the program interfaces 41-42 of the browser application can implement incremental loading of UI design files for users, as described herein. For example, instead of loading an entire UI design file to the browser storage, the program interfaces 41-42 of user computing devices 11-12 can load individual UI design pages 91 from a UI design file based on selection inputs provided by each of the users respectively. Accordingly, when a user of computing device 11 edits a first loaded UI page 91 of a UI design file, change data 94 corresponding to those edits are transmitted to the service interface 60, which propagates the change data 94 to the UI design file 90. When the edited UI page is incrementally loaded to program interface 42 of computing device 12, the UI page 91 will reflect the edits made by the first user.

As provided herein, any number of users may participate in a particular collaboration session. Each user in the collaboration session can incrementally load individual UI pages 91 of a UI design file. Edits made by one user collaborator to a UI page 91 that has not been loaded to another collaborator's device can be propagated by the network computer system 50 to the UI design file 90. Accordingly, incremental loading of individual UI pages 91 of any UI design file 90 at the workplace data store 64 can occur on an individual basis, where edits made by each user can be transmitted as change data 94 back to the service interface 60 for propagation to the UI design file 90.

In certain implementations, the network computer system 50 can include a UI content selector 68 that can determine which UI design files and/or individual UI pages 91 to preload to user computing devices of individual users of the collaboration service. As provided herein, the UI content selector 68 can reference a user profile or other historical user data to determine which UI design files and/or pages 91 a particular user has most recently accessed and/or edited. As further provided herein, the UI content selector 68 can implement other selection criteria and/or machine learning techniques to predict which particular UI design files and/or pages a user is likely to open.

Upon determining or predicting which UI design files and/or pages the user is likely to open, the UI content selector 68 can preload those UI design files/pages 91 to the browser storage of a browser executing on the user computing device. For example, when user computing device 11 initiates the browser application for presenting and making edits to a design in progress 25 on the collaborative canvas 71, the UI content selector 68 can predict which UI design files/pages 91 the user is most likely to wish to access, and cause those UI design files/pages 91 to be preloaded to the browser storage on the user computing device 11. Thereafter, if an offline condition occurs, either on the front end (e.g., the user's network connection) or the backend (e.g., an outage at the network computer system 50), the user is still enabled to access and edit a currently opened UI design file or page and each of the preloaded design files or pages 91 in the browser storage.

In further implementations, the UI content selector 68 can reference a user profile of a user, which can be stored in a profile data store 62 of the network computer system 50. As provided herein, the user profile can store routine behavioral data, activity data, and/or other predictive information that the UI content selector 68 can utilize to predict which individual content items, cards, UI pages, or UI design files with which the user is likely to want to interact. The UI content selector 68 can utilize the information in the profile data store 62 (e.g., using machine learning techniques) to make such predictions and preload content in the browser memory of a user device automatically when the user launches the browser application.

In certain examples, change data 94 is stored or cached locally until the network link between the user computing device 11 and the network computer system 50 is restored. Thereafter, the change data 94 is propagated by the service interface to the relevant UI design file 90 accordingly. In accordance with examples provided herein, the incremental loading features and change propagation can function to improve loading speed and overall performance of the collaborative design session, thereby reducing loading delays as compared to loading the entire UI design file 90 prior to enabling user interactivity.

### Example User Interfaces

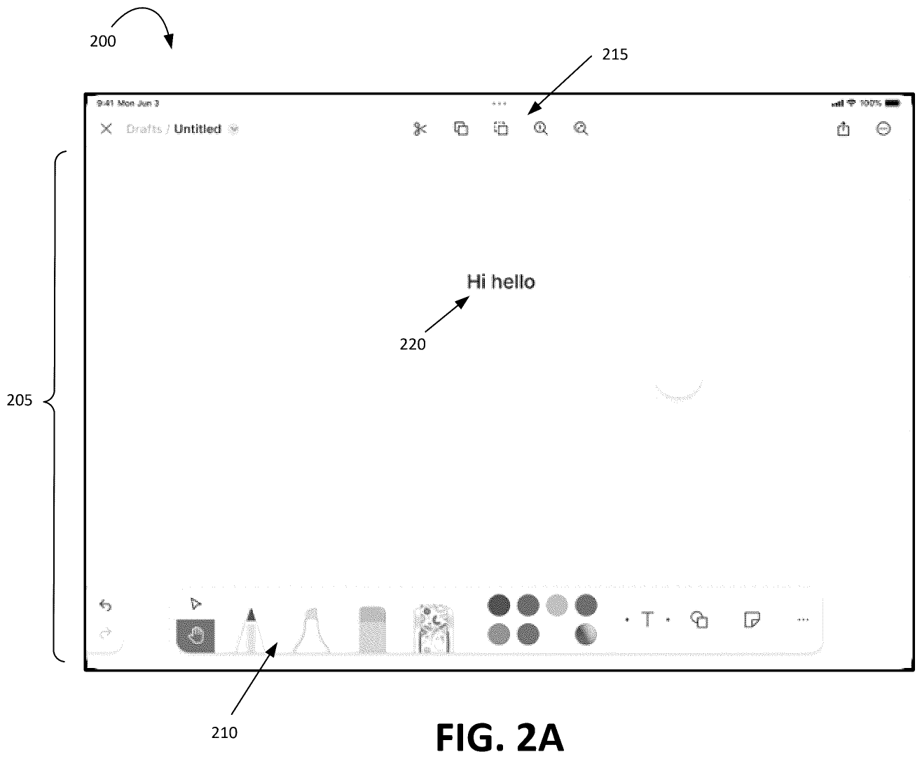

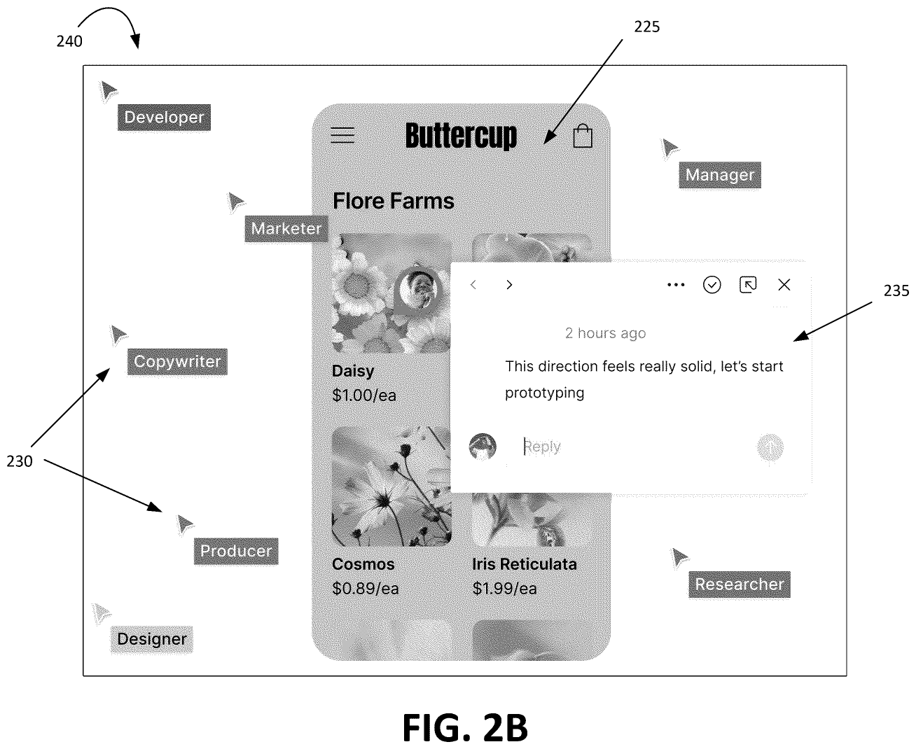

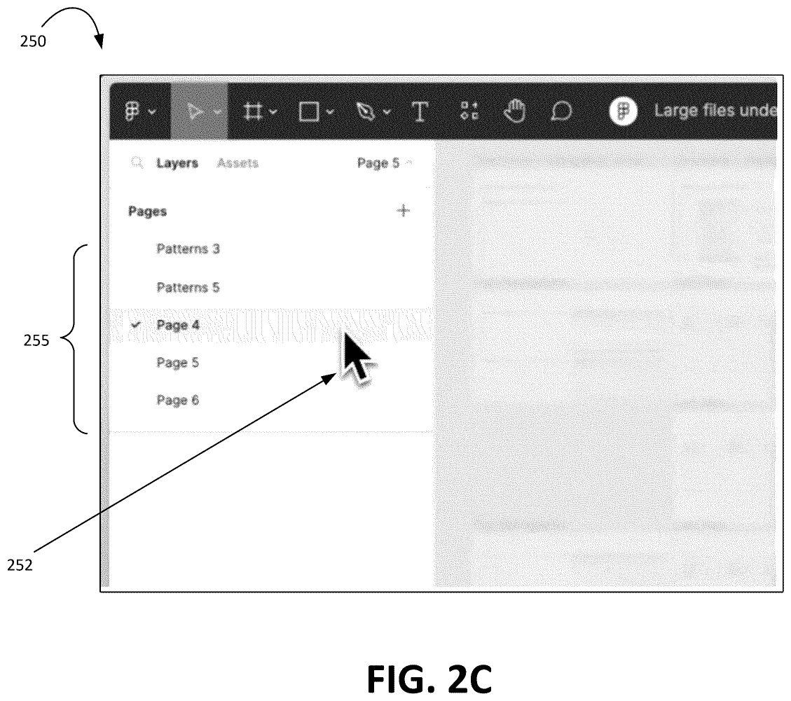

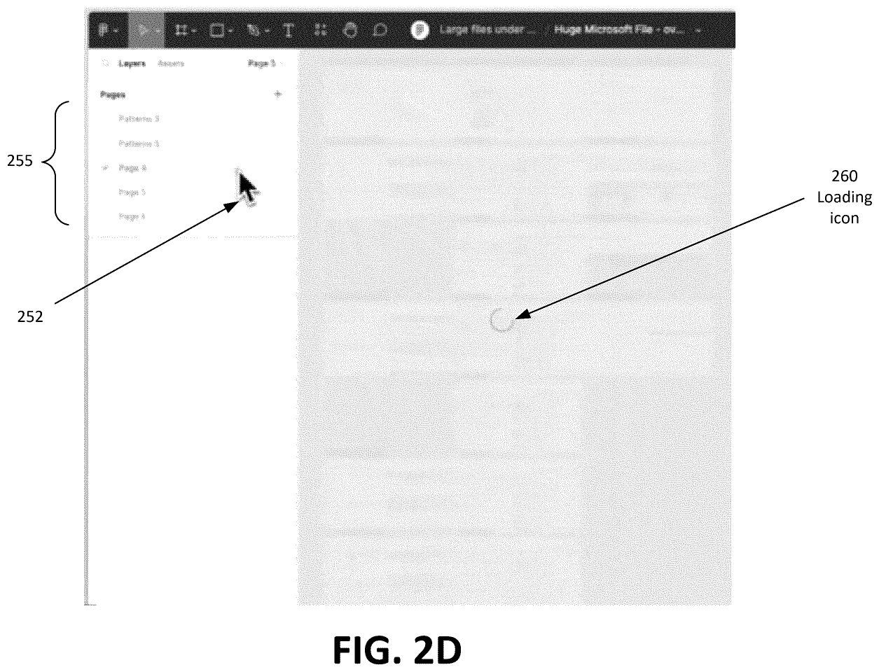

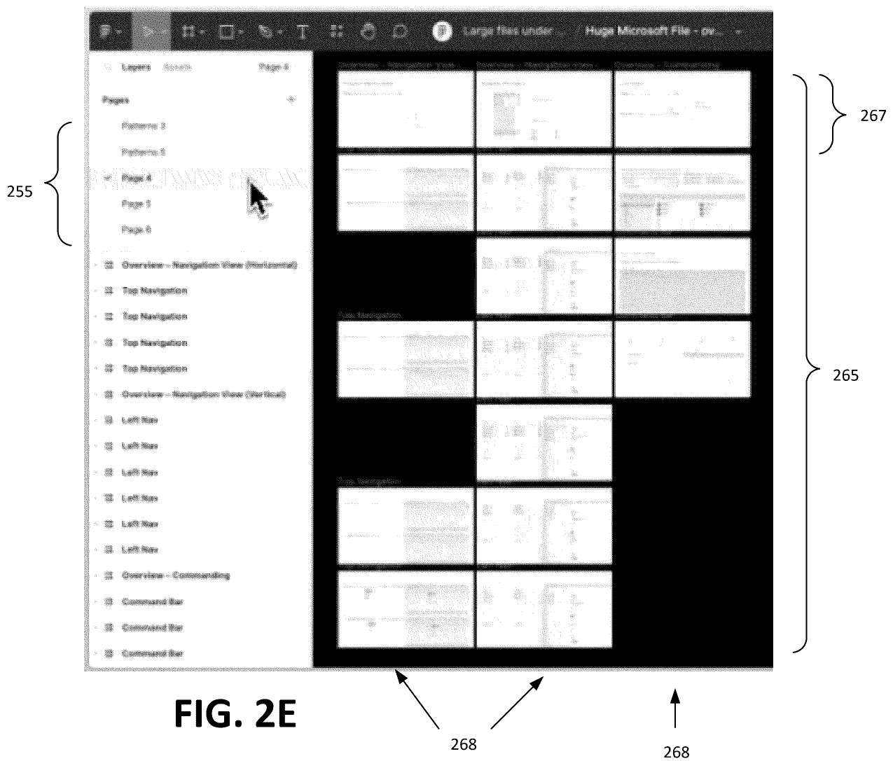

FIG. 2A illustrates an example collaboration user interface 200 for creating a user interface (UI) design file, according to one or more examples. In various implementations, the user interface 200 can be presented on a user computing device 100, as shown and described in connection with FIG. 1A, or user computing devices 11-12 of any number of collaborators participating in a collaboration session, as shown and described with respect to FIG. 1B.

In certain examples, the user interface 200 can present a collaborative canvas 205 providing an initial template for creating a UI design. The user can open the browser application corresponding to the collaborative web service, which can cause the collaborative canvas 205 to be presented, along with a creative tool bar 210 and editing tool bar 215 providing the user with creative and editing tools for designing a user interface. As provided herein, the user can initiate or join a collaboration session with any number of user collaborators to provide comment, react to, or provide emojis to the contributions of other collaborators. As shown in FIG. 2A, the user interface 200 includes a welcome message 220, and can further provide a “how to” feature or tutorial of getting started with creating a UI design.

In various examples, the user can interact with the creative tool bar features and editing tool bar features for creating a UI design, which can be saved as a UI design file. In doing so, the user can create various interface panels comprising customized shapes and functionality configured by the user and any collaborator joining the user in the collaboration session. As provided herein, the UI design file can include any number of UI pages, each of which can include UI frames and designs that can be edited by the user and user collaborators to create a particular user experience.

FIG. 2B illustrates an example collaboration interface 240 during a collaboration session with multiple users collaborating on a UI design, according to one or more examples. As shown in FIG. 2B, each user collaborator can be provided with a cursor indicator 230 that enables the user collaborator to provide creative input, make edits and configurations, and provide comment based on a currently presented UI design in progress 225.

As further shown in FIG. 2B, a UI design in progress can include a UI page 225 (e.g., for an application under design) that can include any number of configurable features (e.g., a drop-down menu feature, icons, browsing features, product or service listings, checkout and purchase features, etc.). In certain examples, the user is able to provide comments and message other user collaborators in a comment panel 235 that overlays the collaborative canvas 205. In the example shown in FIG. 2B, the collaborators may finalize a design for a particular user interface and provide comments to initiate prototyping of the UI design.

In the context of the present disclosure, the UI page 225 can be incrementally loaded on the computing device of each of the collaborators in the collaboration session. For example, each collaborator may select the UI page 225 from a UI design file (e.g., that each of the collaborators are working on or otherwise providing input towards). In response, the browser application can retrieve the individual UI page 225 as opposed to the entire UI design file in which the UI page 225 is included, which can facilitate increased loading speed of the UI page 225.

In further examples, each of the collaborators can individually select additional UI pages of the UI design file, which may be independently incrementally loaded to that collaborator's computing device (e.g., retrieved from the backend network computer system by the browser application). Furthermore, change data corresponding to each collaborator's edits to an incrementally loaded UI page can be propagated to the UI design file on the backend in real time, such that when another collaborator opens the edited UI page for incremental loading, the edits are present on UI page.

FIGS. 2C through 2E illustrate a sequence of incremental loading a UI design file. Referring to FIG. 2C, a UI design interface 250 can be presented on the computing device of a user and can implement incremental loading and/or dynamic content loading, in accordance with examples described herein. The user may interact with the UI design interface 250 using input features, such as a mouse, keyboard, and/or touchscreen. For example, the user may utilize a cursor 252 to provide selection inputs to edit a design in progress (corresponding to a UI design file) presented on the display. As provided herein, the UI design file may be incrementally loaded and/or the browser application may perform dynamic content loading of the UI design file.

As shown in FIG. 2C, the presented content include a listing of UI pages 255 that the user can select for presentation on the display to review and/or make edits. While the UI pages 255 are listed, they may not be loaded yet since the browser application is implementing incremental loading and/or dynamic content loading. For example, Page 4 of the UI design file may yet to be loaded, and the user can utilize the cursor 252 to select Page 4.

In further examples, the listing of UI pages 255 may include UI pages that have been preloaded to the browser memory (e.g., via predictive preloading techniques described herein). As described herein, the preloaded UI pages and/or content features of UI pages (e.g., a first set of cards of the UI page), or the browser application can implement dynamic content loading in which an initial set of content items (e.g., a first set of cards of the UI page) is loaded and presented on the display for user interaction.

As shown in FIG. 2D, upon selecting Page 4 from the listing of UI pages 255 using cursor 252, a brief loading screen is presented with a loading icon 260 as Page 4 is loaded by the browser application. In particular, the browser application does not retrieve Page 4 from the UI design file stored at the backend network computer system until the user selects Page 4 from the listing of UI pages 255. It is contemplated that the minimal loading time (e.g., a faction of a second) for loading an individual UI page or a subset of content items of the UI page can provide a performance benefit over previous methods of initially loading an entire UI design file from the outset.

In particular, a relatively large UI design file may involve several seconds of loading time, impacting user experience and retention. For these larger UI design files, the browser application and/or backend network computer system may determine a plan for preparing the UI design file for the user, which can comprise an optimization based on the UI file data of the UI design file, as described above in connection with FIG. 1A. The UI file data can indicate the overall checkpoint size of the UI design file, individual UI pages of the UI design file, and the various content features or cards of the individual UI pages. Based on the optimization, the browser application can preload certain UI files or UI pages of a UI file, perform incremental loading of UI pages in response to user input selecting those pages, and/or can perform dynamic content loading of individual UI pages (e.g., for UI pages having a checkpoint size above a certain threshold).

Referring to FIG. 2E, Page 4 265 comprising a set of cards 268 is loaded and presented on the user's display screen following the brief loading screen shown in FIG. 2D. For dynamic content loading implementations, a first set of content features 267 may be initially loaded, and as the user interacts with additional content features (e.g., other individual cards or subsets of cards) the browser application may load these features accordingly. As described herein, the user can interact with individual cards 268 to provide edits to the UI design file, which are then propagated to the UI design file stored at the backend network computer system. Accordingly, if several user collaborators are participating in a UI design session—each of which interact with the UI design file locally as the browser application performs any combination of predictive UI page or content preloading, incremental loading, and/or dynamic content loading—any changes made to a particular UI page made by one user collaborator are present when the same UI page is incrementally loaded or dynamically loaded on another user collaborator's device.

### Methodology

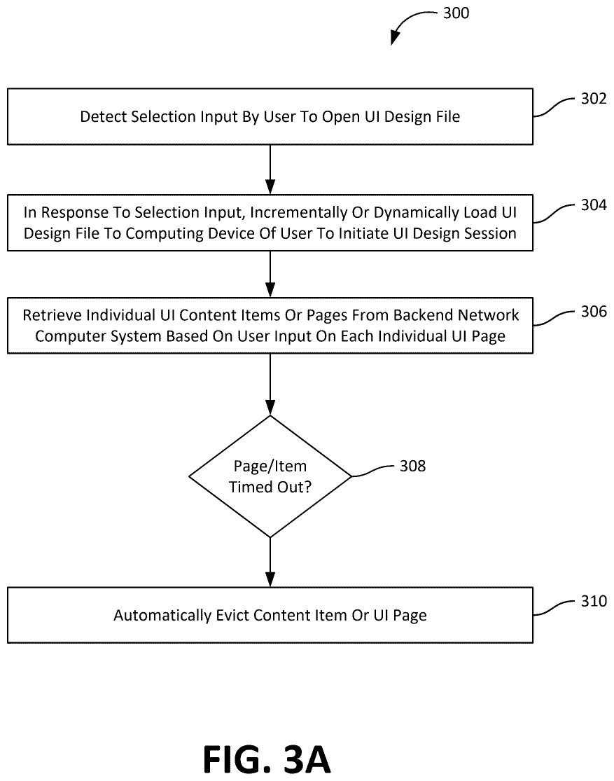

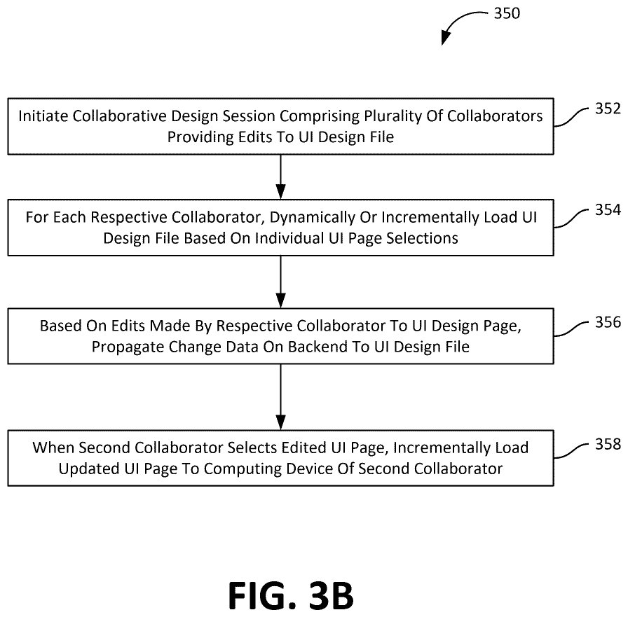

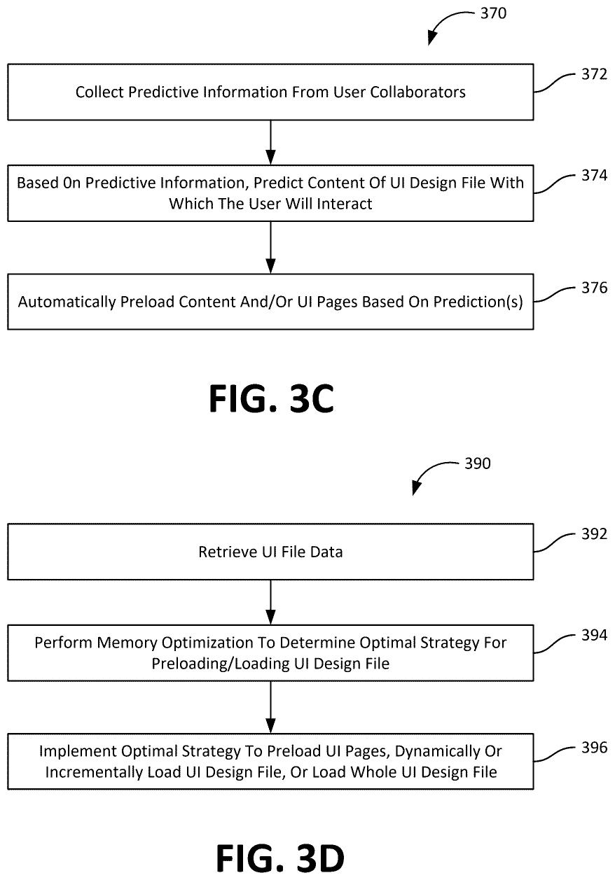

FIGS. 3A through 3D are flow charts 300, 350, 370, 390 describing processes for predictive preloading, incremental loading, and/or dynamic content loading of UI design files, according to one or more examples. In the below description of FIGS. 3A through 3D, reference may be made to reference characters representing various features as shown and described with respect to FIGS. 1A through 2E. Furthermore, the processes described with respect to FIGS. 3A through 3D may be performed by an example user computing device 100 executing a browser application 110, an example network computer system 50, or a combination of a user computing device 100 and network computer system 50 as shown and described above with respect to FIGS. 1A and 1B. Still further, while the processes shown in FIGS. 3A through 3D are shown in a particular order, any step may be performed prior to, in conjunction with, or subsequent to any other step in the flow charts 300, 350, 370, and 390 of FIGS. 3A through 3D.

Referring to the flow chart 300 of FIG. 3A, in various examples, at block 302, a browser application 110 executing on a user computing device 100 may detect a selection input by a user to open a UI design file. In certain implementations, the UI design file may be stored at a backend network computer system 155 that facilitates a web-based collaborative service that enables multiple remote collaborators to design a user interface and user experience of, for example, a mobile or web application. At block 304, in response to the selection input by the user, the browser application 110 can incrementally load or perform dynamic content loading of the UI design file to the computing device of the user to initiate a UI design session.

According to some examples, the UI design session can comprise a single user session in which the user provides input and makes edits to the UI design file. In variations, the UI design session can include multiple user collaborators that may be remote from each other, each of which can select the UI design file for incremental loading. At block 306, when the user selects the UI design file for incremental or dynamic content loading, the browser application 110 can retrieve individual UI content items (e.g., for dynamic content loading) or individual UI pages of the UI design file from the backend network computer system 155 based on the user selecting each individual UI page. As a result, load times for certain individual pages are decreased as compared to loading the entire UI design file from the outset.

In certain implementations, the browser application 110 can further perform auto-eviction functions for UI design files, individual UI pages of a UI design files, or individual content features (e.g., cards) of the UI pages. For example, when each UI page or content item is loaded, the browser application 110 can initiate a timer for that page or content item. At decision block 308, the browser application may determine whether the UI page or content item has timed out. In other words, the browser application may detect that the user has not interacted with the UI page or content item for greater than a threshold amount of time (e.g., two minutes). At block 310, if the UI page or individual content item has timed out, the browser application 110 may automatically evict the UI page or content item accordingly.

For example, when a card presented on a UI page is timed out, the browser application 110 can perform a screenshot of the card to enable the card to visually persist on the user's display screen. However, all memory intensive features of the card can be archived (e.g., stored at the backend network computer system 50) while the card presented on the user's display screen will no longer consume browser memory. If the user wishes to interact with the evicted card again, the user may provide a selection input on the card, and the browser application will retrieve the memory intensive features from the backend via the dynamic content loading techniques described herein.

As such, the browser application 110 can continuously prepare the UI design file or multiple UI design files for the user using dynamic content loading, incremental loading, and auto-eviction techniques in accordance with, for example, a memory optimization based on UI file data for the UI design file or the multiple UI design files (as discussed below with respect to FIG. 3D). In further examples, the browser application 110 can further implement predictive preloading of whole UI design files, individual UI pages, or content items at any time based on real-time user inputs and/or the predictive routine or activity data of the user (e.g., as stored in the profile data store 62).

FIG. 3B is a flow chart 350 describing a process for dynamic content loading or incremental loading and change data propagation for a plurality of remote collaborators, according to one or more examples. Referring to the flow chart 350 of FIG. 3B, at block 352, a computing environment comprising multiple user computing devices 11-12 of a plurality of user collaborators and a network computer system 50 can initiate a collaborative design session in which the user collaborators can provide edits to a UI design file. At block 354, for each respective user collaborator, a browser application 110 executing on the respective collaborator's computing device can perform dynamic content loading or can incrementally load the UI design file based on individual UI page selections by the respective collaborator. Accordingly, each collaborator may independently interact with the UI design file, with individual UI pages being loaded to the computing device of each user, who may then provide input and edits to the individually loaded UI pages.

At block 356, based on the edits made by each respective user collaborator to the incrementally loaded UI pages or individual content items on those user's computing devices, the browser application 110 can propagate change data corresponding to the edits by each user collaborator to the UI design file stored at the backend computer system 155. Accordingly, individual pages or content item that have yet to be loaded to the user computing devices of collaborators in the UI design session can be updated on the backend, and when they are eventually loaded to those computing devices, the changes made by the respective collaborator may be reflected on the updated UI page. As such, at block 358, when a second collaborator selects the edited UI page, the browser application 110 executing on the second collaborator's computing device can dynamically or incrementally load the updated UI page.

FIG. 3C is a flow chart 370 describing a process for automatic incremental preloading of UI design files based on predictive information, according to one or more examples. Referring to FIG. 3C, at block 372, the backend computer system 50 can collect predictive information from user collaborators utilize to the collaborative web service. For example, the network computer system 50 can compile a user profile in a profile data store 62 for each user collaborator that can include information corresponding to user routines and activities in engaging with the collaborative web service and/or can implement one or more machine learning techniques to identify predictive behaviors of the user collaborator.

As a basic example, a user may routinely open a UI design file under edit at a certain time of the week (e.g., Monday morning at 8 am). Upon determining this routine, upon launch, the browser application 110 can automatically preload the UI design file under edit to the local browser storage 115. In a further example, the network computer system 50 can identify a UI page of the UI design file that the user has last edited. Upon identifying this predictive information, the browser application 110 may be caused to automatically preload the UI page when the browser application 110 is launched, or in real time in response to user edits and inputs on a particular UI design file.

More complex scenarios are also contemplated, in which a particular user may have several UI design files stored at the workspace data store 64 on the backend network computer system 50, and in which predictive user data can include (i) recency of interaction with one or more UI design files, individual UI pages, and/or individual content items or cards of the one or more UI design files, (ii) tag information for any UI page or cards in which the user has been recently mentioned or tagged, (iii) calendared collaboration sessions in which the user is scheduled to participate, and which involve a particular UI design file, (iv) any scheduled deadline information for a particular UI design file, and the like. In still further examples, the browser application 110 can perform predictive preloading of content items and/or UI pages based on real time interactions by the user with a particular UI design file.

At block 374, based on the predictive information of the user, the network computer system 50 can predict content of a UI design file with which the user is likely to interact. In certain implementations, the network computer system 50 and/or browser application 110 may respond to real-time user interactions with the UI design file to predict individual content items, cards, and/or UI pages with which the user is likely to interact. For example, the user may provide edits to a last card presented on a UI page, which can indicate that the user is likely to provide edits or otherwise interact with a next card on a next UI page of the UI design file. Based on this indication, the browser application 110 can automatically preload the next UI page or an initial set of cards of the next UI page to the load browser storage 115.

At block 376, based on the predictions (e.g., based on predictive information stored at the backend network computer system 50 and/or real-time input provided by the user), the browser application 110 can automatically preload content items (e.g., cards) and/or UI pages to the local browser storage 115. Thereafter, when the user selects the preloaded items or UI pages, they are presented on the user's display immediately. As provided herein, the predictive preloading techniques may be implemented in combination with any of the dynamic content loading, incremental UI page loading, and/or auto-eviction techniques described throughout the present disclosure.

FIG. 3D is a flow chart 390 describing a process for determining an optimal strategy for preparing a UI design file for a user, according to one or more examples. Referring to FIG. 3D, at block 392 a memory optimizer 150 the browser application 110 can retrieve UI file data of a particular UI design file (e.g., in response to a user selection of the UI design file). In alternative embodiments, the memory optimizer 150 may be housed at the network computer system 50, which can perform the memory optimization techniques described herein.

As provided herein, the UI file data can indicate checkpoint size of the UI design file, individual pages of the UI design file, and/or individual content items (e.g., cards) of the UI design file. Based on this information, at block 394, the memory optimizer 150 can perform a memory optimization to determine an optimal strategy for preloading and/or loading the UI design file. Accordingly, at block 396, the browser application 110 can implement the optimal strategy for preparing the UI design file for the user. As described herein, the optimal strategy can comprising any combination of preloading content items, UI pages, or an entire UI design file, dynamic content loading of content items of individual UI pages, incremental loading of whole UI pages, or loading entire UI design files. The optimal strategy can further be implemented using the auto-eviction and/or archiving techniques described above.

It is contemplated that the predictive preloading, dynamic content loading, incremental page loading, and auto-eviction techniques described herein can result in an overall performance improvement on each of the user collaborator's computing device, which can increase browser memory usage efficiency and loading speeds while decreasing latency and bandwidth requirements in the overall collaborative computing environment. Such techniques can be combined with preloading of UI design files and/or individual UI pages of UI design files (e.g., based on recency or machine learning techniques described herein) to provide further performance benefits in loading speed, memory usage, latency, etc.

### Network Computer System

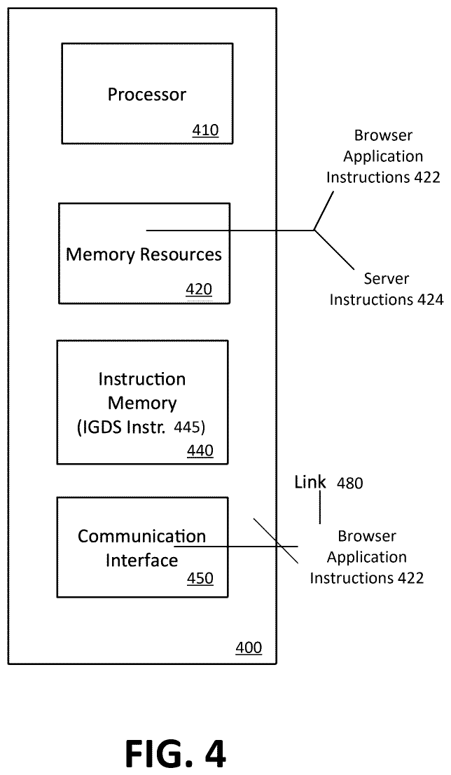

FIG. 4 illustrates a computer system on which one or more embodiments can be implemented. A computer system 400 can be implemented on, for example, a server or combination of servers. For example, the computer system 400 may be implemented as the network computer system 155, 50 of FIGS. 1A and 1B.

In one implementation, the computer system 400 includes processing resources 410, memory resources 420 (e.g., read-only memory (ROM) or random-access memory (RAM)), one or more instruction memory resources 440, and a communication interface 450. The computer system 400 includes at least one processor 410 for processing information stored with the memory resources 420, such as provided by a random-access memory (RAM) or other dynamic storage device, for storing information and instructions which are executable by the processor 410. The memory resources 420 may also be used to store temporary variables or other intermediate information during execution of instructions to be executed by the processor 410.

The communication interface 450 enables the computer system 400 to communicate with one or more user computing devices, over one or more networks (e.g., cellular network) through use of the network link 480 (wireless or a wire). Using the network link 480, the computer system 400 can communicate with one or more computing devices, specialized devices and modules, and/or one or more servers.

In examples, the memory resources 420 can store multiple instruction sets, including a browser instruction set 422 and a server instruction set 424. The processor 410 may execute the server instruction set 424, stored with the memory resources 420, in order to enable the network computing system to implement the collaborative platform and operate as the network computer system 155, 50 in examples such as described with FIG. 1A and FIG. 1B. The computer system 400 may also include additional memory resources (“instruction memory 440”) for storing executable instruction sets (“browser instructions 422”) such as may be embedded with web pages or transmitted to the browser application 110, to enable user computing devices to implement functionality such as described throughout the present disclosure. The browser instructions 422 can be communicated to the computing devices of the users of the collaborative platform, to enable each of the computing devices to implement an example method such as described with FIG. 3.

As such, examples described herein are related to the use of the computer system 400 for implementing the techniques described herein. According to an aspect, techniques are performed by the computer system 400 in response to the processor 410 executing one or more sequences of one or more instructions contained in the memory 420. Such instructions may be read into the memory 420 from another machine-readable medium. Execution of the sequences of instructions contained in the memory 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

### User Computing Device

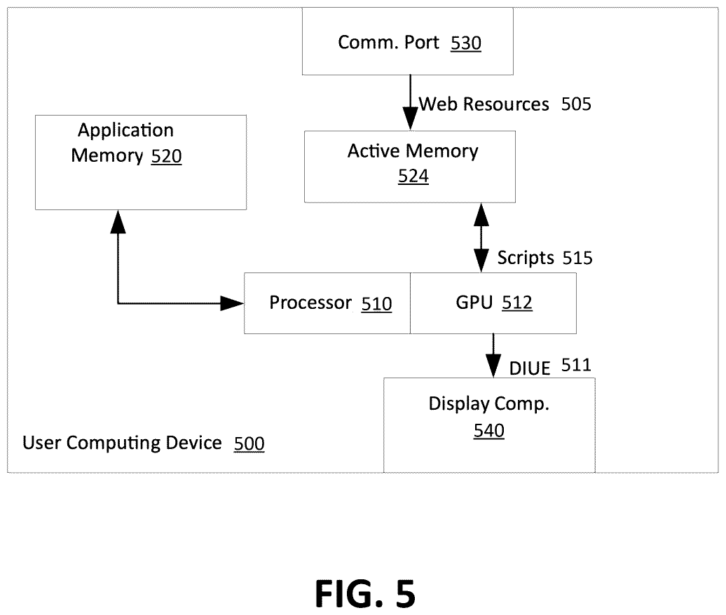

FIG. 5 illustrates a user computing device for use with one or more examples, as described. In examples, a user computing device 500 can correspond to, for example, the user computing device 100 as shown and described with respect to FIG. 1A, and can comprise a smartphone, tablet computer, AR or VR headset, or other touchscreen-based personal computer having graphics processing capabilities that are suitable for enabling renderings of design interfaces and graphic design work.

In examples, the computing device 500 includes a central or main processor 510, a graphics processing unit (GPU) 512, memory resources 520, and one or more communication ports 530. The computing device 500 can use the main processor 510 and the memory resources 520 to store and launch a hybrid web-native collaboration application. In certain examples, a user can operate the application to access a network site of the network collaboration platform, using the communication port 530, where one or more web pages or other web resources 505 for the network collaboration platform can be downloaded. In certain examples, the web resources 505 can be stored in the active memory 524 (cache).

As described by various examples, the processor 510 can detect and execute scripts and other logic which are embedded in the web resources 505 in order to implement the collaborative canvas. In some of the examples, some of the scripts 515 which are embedded with the web resources 505 can include GPU accelerated logic that is executed directly by the GPU 512.

The main processor 510 and the GPU can combine to render a design in progress on a display component 540 (e.g., touch-sensitive display device). The rendered design interface can include web content from the web aspect of the hybrid application, as well as design interface content and functional elements generated by scripts and other logic embedded with the web resources 505.

### Conclusion

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A computing device comprising:
a display device;
a network communication interface;
one or more processors; and
a memory storing instructions that, when executed by the one or more processors, cause the computing device to:
detect a selection input by a user of the computing device to open a user interface (UI) design file and initiate a UI design session; and
in response to the selection input, incrementally load the UI design file to the computing device of the user for presentation on the display device.

2. The computing device of claim 1, wherein incrementally loading the UI design file to the computing device of the user comprises retrieving individual UI pages of the UI design file from a backend network computer system based on the user providing input to select each of the individual UI pages.

3. The computing device of claim 1, wherein detecting the selection input and incrementally loading to UI design file are performed by a browser application that facilitates the UI design session.

4. The computing device of claim 3, wherein the browser application further enables a plurality of remote collaborators to participate in the UI design session with the user and provide input for updating the UI design file.

5. The computing device of claim 1, wherein executed instructions cause the computing device to incrementally load the UI design file to the computing device of the user by sequentially loading each respective UI page of a plurality of UI pages of the UI design file to the computing device based on selective inputs by the user selecting the respective UI page.

6. The computing device of claim 5, wherein an unloaded UI page of the plurality of UI pages includes one or more UI features that are affected by one or more edits made to one or more corresponding UI features on the respective UI page.

7. The computing device of claim 6, wherein the executed instructions further cause the computing device to:
transmit change data corresponding to the one or more edits made to the one or more corresponding UI features on the respective UI page to a backend network computer system;
wherein the backend network computer system processes the change data to automatically implement the one or more edits on the unloaded UI page.

8. The computing device of claim 7, wherein the UI design session includes a plurality of remote collaborators on the UI design file, and wherein the backend network computer system incrementally uploads the unloaded UI page to each respective remote collaborator of the plurality of remote collaborators in response to input from the respective remote collaborator selecting the unloaded UI page.

9. The computing device of claim 8, wherein edits made by each of the plurality of remote collaborators to any UI page of the UI design file are propagated to active workspace data corresponding to the UI design file at the backend network computer system.

10. The computing device of claim 1, wherein incrementally loading the UI design file comprises dynamically loading content items of individual UI pages of the UI design file as the user provides input to display the content items or interacts with the content items.

11. The computing device of claim 10, wherein the executed instructions further cause the computing device to:
automatically evict the individual UI pages or individual content items of the individual UI pages after a predetermined time period in which the user does not interact with the individual UI pages or the individual content items.

12. The computing device of claim 11, wherein automatically evicting the individual UI pages or the individual content items comprises recording one or more screenshots for display on the computing device and archiving the individual UI pages or the individual content items at a backend network computer system.

13. A non-transitory computer readable medium storing instructions that, when executed by one or more processors of a computing device, cause the computing device to:
detect a selection input by a user of the computing device to open a user interface (UI) design file and initiate a UI design session; and
in response to the selection input, incrementally load the UI design file to the computing device of the user for presentation on a display device of the computing device.

14. The non-transitory computer readable medium of claim 13, wherein incrementally loading the UI design file to the computing device of the user comprises retrieving individual UI pages of the UI design file from a backend network computer system based on the user providing input to select each of the individual UI pages.

15. The non-transitory computer readable medium of claim 13, wherein detecting the selection input and incrementally loading to UI design file are performed by a browser application that facilitates the UI design session.

16. The non-transitory computer readable medium of claim 15, wherein the browser application further enables a plurality of remote collaborators to participate in the UI design session with the user and provide input for updating the UI design file.

17. The non-transitory computer readable medium of claim 13, wherein executed instructions cause the computing device to incrementally load the UI design file to the computing device of the user by sequentially loading each respective UI page of a plurality of UI pages of the UI design file to the computing device based on selective inputs by the user selecting the respective UI page.

18. The non-transitory computer readable medium of claim 17, wherein an unloaded UI page of the plurality of UI pages includes one or more UI features that are affected by one or more edits made to one or more corresponding UI features on the respective UI page.

19. The non-transitory computer readable medium of claim 18, wherein the executed instructions further cause the computing device to:
transmit change data corresponding to the one or more edits made to the one or more corresponding UI features on the respective UI page to a backend network computer system;
wherein the backend network computer system processes the change data to automatically implement the one or more edits on the unloaded UI page.

20. A computer-implemented method performed by one or more processors of a computing device, the method comprising:
detecting a selection input by a user of the computing device to open a user interface (UI) design file and initiate a UI design session; and
in response to the selection input, incrementally loading the UI design file to the computing device of the user for presentation on a display device of the computing device.
